(19) United States
(12) Patent Application Publication
(10) Pub. No.: US 2023/0334751 A1
(43) Pub. Date: Oct. 19, 2023

(54) SYSTEM AND METHOD FOR VIRTUAL EVENTS PLATFORM

(71) Applicant: ANNA MARIE EVENTS, LLC, San Francisco, CA (US)

(72) Inventors: Douglas Randall BAILEN, Ventura, CA (US); Anna Marie REMBOLD, San Francisco, CA (US); Louise Marie GLASGOW, Mill Valley, CA (US); Zach SCHAPEL, Costa Mesa, CA (US)

(21) Appl. No.: 18/136,836

(22) Filed: Apr. 19, 2023

Related U.S. Application Data
(63) Continuation of application No. PCT/IB2021/000687, filed on Oct. 19, 2021.

(30) Foreign Application Priority Data
Oct. 19, 2020 (NZ) 769133

(51) Int. Cl. G06T 19/00; G06T 15/00

(52) U.S. Cl. CPC G06T 15/005; G06T 19/003

(57) ABSTRACT

Certain aspects relate to systems configured to operate a virtual event platform hosting virtual attendees.

### CROSS-REFERENCE TO RELATED APPLICATIONS

This Application is a continuation of International Patent Application No. PCT/IB2021/000687, filed on Oct. 19, 2021, which claims priority to NZ Application No. 769133, filed on Oct. 19, 2020, the entire contents of each of which are hereby incorporated by reference.

### BACKGROUND

### Field

The invention generally relates to computer applications for the presentation of virtual events and in particular to the expedient creation of a virtual event environment for virtual events.

### Description of Related Art

Virtual events are often desired to take place within a three dimensional virtual space. Attendees of a virtual event will be provided with a visual representation of the three dimensional space, within which they are provided with media which they are able to view on their display device. The media may include, for example, artwork, architectural elements, a visual presentation and similar three-dimensional visual material, and audio.

To create a virtual event, a three dimensional visual space must be generated. One option to generate a three dimensional visual space is for a developer to design and build a custom virtual building or virtual environment using a combination of 3D designers, developers, graphic artists, and web developers. However, this option is costly and takes weeks to months, depending on the level of complication of the design.

Another option to generate a three dimensional visual space is to create a three dimensional visual space based on a template to recreate multiple static, customized replicas. This option facilitates greater efficiency, but requires customized redesign and rebuilding each time a change to the virtual space is required. Further, real-time changes and updates are impossible to generate due to the redesign and rebuilding process that must be undertaken.

A further issue is that there is a desire to create virtual event spaces that are customized or personalised to the interests of the client such that a personal connection with the space is created. A personal connection is typically valued for gatherings of a corporate customer base, corporate teams, associations, club, social or family nature. However, there are few options that allow easy creation of a personalised virtual event space.

It is an object of the present invention to go at least some way toward improving on or ameliorating the abovementioned issues, or which at least provides the public with a useful choice. Other objects of the invention may become apparent from the following description, which is given by way of example only.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

### SUMMARY

In one broad aspect the invention relates to a system for providing a virtual event platform hosting virtual attendees, the system comprising: one or more processors configured to execute machine-readable instructions to: provide a floor plan representing a virtual event space; determine a plurality of nodes within the virtual event space located within the floor plan, and a selection of pathways connecting a selection of the plurality of nodes; build a three dimensional virtual event space based on the virtual floor plan and plurality of pathways; provide one or more virtual graphical content locations within the virtual three dimensional space; receive graphical content associated with the one or more virtual graphical content locations; and render cinematic content with a three dimensional cinematic content generation engine, the cinematic content representing: viewing of the three dimensional virtual event space from the location of the node, and travel through the event space from one node to another; the cinematic content containing the graphical content represented at graphical content locations; and providing the cinematic content to a virtual attendee.

In some embodiments, the instructions further comprise: providing one or more selectable decision points to the virtual attendee, whereby selection of any one decision point is operable to cause travel through the event space from one node to another.

In some embodiments, travel through the event space from one node to another comprises delivery of cinematic content to the virtual attendee representing a visual display of movement from one node to another.

In some embodiments, the pathways are selectable based on a control criteria, the control criteria comprising one or more of: a time based component; or a trigger component, the trigger component based on one or more behavioral characteristics of the virtual attendee.

In some embodiments, the system further comprises a scheduling controller operable to determine the selection of pathways based on time, and/or one or more decision points received from an attendee.

In another broad aspect the invention consists in a method of generating a virtual event platform hosting virtual attendees, the method comprising operating a processor to: receive virtual event space data comprising a floor plan, a plurality of nodes representing a virtual location within the floor plan, a plurality of virtual pathways connecting a selection of the plurality of nodes, and a plurality of virtual graphical content locations within the virtual event space; receive user data comprising identification of the virtual content locations with graphical content; receive a selection of graphical content based on the user data; render first person three dimensional cinematic content at the location of each node based on the virtual event space data and the selection of graphical content; render three dimensional cinematic content comprising first person travel along each virtual pathway; and output the rendered cinematic content to the virtual attendees.

In some embodiments, the at least one node comprises a visual decision point, selectable by the virtual attendee, whereby selection of any one decision point causes the processor to output rendered cinematic content comprising travel through the event space from one node to another.

In some embodiments, the processor is configured to transmit data representing the virtual location of an attendee to a user server.

In some embodiments, the user server is configured to transmit notifications to an attendee device based on the virtual location data.

In some embodiments, the method further comprises operating the processor to output rendered cinematic content based on the received location data, the content comprising new or existing virtual pathways between nodes.

In some embodiments, the output of cinematic content comprises first person travel along each virtual pathway is based on control criteria, the criteria comprising one or more of: a time based component; or a trigger component, the trigger component based on one or more behavioral characteristics of the virtual attendee.

In some embodiments, the processor is configured to output rendered cinematic content based on a schedule or timed events, and/or one or more inputs received from an attendee or user.

In another broad aspect the invention consists in a system configured to operate a virtual event platform hosting virtual attendees, the system comprising a server connected to a plurality of virtual attendee devices, the server comprising a processor configured to: receive virtual event space data comprising a floor plan, a plurality of nodes representing a virtual location within the floor plan, a plurality of virtual pathways connecting a selection of the plurality of nodes, and a plurality of virtual graphical content locations within the virtual event space; receive user data comprising identification of the virtual content locations with graphical content; receive a selection of graphical content based on the user data; render first person three dimensional cinematic content at the location of each node based on the virtual event space data and the selection of graphical content; render three dimensional cinematic content comprising first person travel along each virtual pathway; and output the rendered cinematic content to the virtual attendees devices.

In some embodiments, the invention relates to any one or more of the above statements in combination with any one or more of any of the other statements. Other aspects of the invention may become apparent from the following description, which is given by way of example only and with reference to the accompanying drawings.

The entire disclosures of all applications, patents and publications, cited above and below, if any, are hereby incorporated by reference. This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The term “and/or” referred to in the specification and claim means “and” or “or”, or both. The term “comprising” as used in this specification and claims means “consisting at least in part of.” When interpreting statements in this specification and claims that include that term, the features, prefaced by that term in each statement all need to be present but other features can also be present. Related terms such as “comprise” and “comprised” are to be interpreted in the same manner.

It is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

As used herein, the terms “communication” and “communicate” may refer to the reception, receipt, transmission, transfer, provision, and/or the like of information, such as data, signals, messages, instructions, commands, and/or the like. For one unit, such as a device, a system, a component of a device or system, combinations thereof, and/or the like to be in communication with another unit means that the one unit is able to directly or indirectly receive information from and/or transmit information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit, where a third unit is located between the first unit and the second unit, processes information received from the first unit and communicates the processed information to the second unit. In some non-limiting embodiments, a message may refer to a network packet such as a data packet, and/or the like that includes data. It will be appreciated that numerous other arrangements are possible.

As used herein, the term “server” may refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers such as servers or other computerized devices, directly or indirectly communicating in the network environment may constitute a “system,” such as a merchant’s point-of-sale system. Reference to “a server” or “a processor,” as used herein, may refer to a previously recited server and/or processor that is recited as performing a previous step or function, a different server and/or processor, and/or a combination of servers and/or processors. For example, a first server and/or a first processor that is recited as performing a first step or function may refer to the same or different server and/or a processor recited as performing a second step or function. Further, reference to a server or processor may refer to a group of servers or group of processors, each configured to perform a task. Such tasks may include processes or algorithms that are undertaken by one or more servers of processors.

It is understood in advance that embodiments of this disclosure includes reference to cloud computing, implementation of the teachings recited herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Some embodiments are private clouds where the cloud infrastructure is operated solely for an organization. Other embodiments are community clouds, where cloud infrastructure is shared by several organizations and supports a specific community that has shared concerns such as security requirements, policy, or compliance considerations. The community cloud may be managed by the organizations or a third party and may exist on-premises or off-premises. In some embodiments, a public cloud infrastructure is made available to the general public or a large industry group and is owned by an organization selling cloud services. A cloud computing environment is service oriented with a focus on statelessness, low coupling, modularity, and semantic interoperability. At the heart of cloud computing is an infrastructure comprising a network of interconnected nodes. The cloud computing models may be managed by the organization or a third party and may exist on-premises or off-premises

One applicable implementation model for the present disclosure is by Software as a Service (SaaS). SaaS is the capability provided to the consumer is to use the provider’s applications running on a cloud infrastructure. The applications are accessible from various client devices through a client interface such as a web browser. The consumer does not typically manage or control the underlying cloud infrastructure including network, servers, operating systems, storage, or even individual application capabilities.

As used herein, the term “computing device” may refer to one or more electronic devices that are configured to directly or indirectly communicate with or over one or more networks. The computing device may be a mobile device. As an example, a mobile device may include a cellular phone, smart phone, a portable computer, a smart wearable device such as watches, glasses, lenses, clothing, and/or the like, a personal digital assistant, and/or other like devices. In other non-limiting embodiments, the computing device may be a desktop computer, or other non-mobile computer. Furthermore, the term “computer” may refer to any computing device that includes the necessary components to receive, process, and output data, and normally includes a display, a processor, a memory, an input device, and a network interface.

An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly through peripheral devices.

One or more embodiments of the invention or elements thereof can be implemented in the form of a computer program product including a computer readable storage medium with computer usable program code for performing the method steps indicated. Furthermore, one or more embodiments or elements can be implemented in the form of a system (or apparatus) including a memory, and at least one processor that is coupled to the memory and operative to perform exemplary method steps. Yet further, in another aspect, one or more embodiments of the invention or elements thereof are for carrying out one or more of the process steps described in this specification. The process steps may be undertaken by any one or more of hardware module(s), software module(s) stored in a computer readable storage medium and implemented on a hardware processor, or a combination of the above.

The term “facilitating” includes performing an action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

### DESCRIPTION OF THE DRAWINGS

The invention can be better understood with reference to the following drawings. The features of the drawings are not necessarily to scale relative to each other, emphasis instead being placed upon clearly illustrating the principles of the invention. Furthermore, like reference numerals designate corresponding parts throughout the several views. Additional advantages and details of the invention are explained in greater detail below with reference to the exemplary embodiments that are illustrated in the accompanying figures.

FIG. 1 shows an example of a computer system configured to support embodiments.

FIG. 2 shows a diagram of an environment including the system server connected to multiple users.

FIG. 3 illustrates process steps for providing a virtual event space in accordance with one or more implementations.

FIG. 4 shows a view of exemplary modules within the system that are configured for the implementation of any one or more operations outlined in FIG. 3.

FIG. 5 shows illustrative examples of environment options that may be provided to an organizer of a virtual event.

FIG. 6 shows a schematic view of system including modules and a process whereby a user will build and facilitate a virtual event.

FIG. 7 shows an illustrative example of the control panel including a timeline of scheduled actions within the virtual event.

FIG. 8 shows an exemplary floor plan including a plurality of pathways extending between nodes within the floor plan.

### DETAILED DESCRIPTION

Exemplary methods and systems are described herein. It should be understood that the word “exemplary” is used herein to mean “serving as an example, instance, or illustration.” Any embodiment or feature described herein as “exemplary” or “illustrative” is not necessarily to be construed as preferred or advantageous over other embodiments or features. More generally, the embodiments described herein are not meant to be limiting. It will be readily understood that certain aspects of the disclosed systems and methods can be arranged and combined in a wide variety of different configurations, all of which are contemplated herein.

Embodiments of the invention relate to computer applications for the presentation of virtual events and in particular to the expedient creation of a virtual event space for virtual events.

One measure of performance is the improvement of the amount of time required to render a three dimensional virtual event space.

Another measure of performance is an improvement in the control options available to a user tasked with creating the virtual event space.

Another measure of performance is the ability for visual changes to the virtual event space to be made by a user in an amount of time that does not disrupt the virtual experience of any virtual attendees. Such a measure of performance typically requires a near real-time update ability.

Embodiments relate to virtual environments that are all based on a floor plan template. The template is associated with a virtual pathway, and the virtual pathway is associated with environmental aspects including rooms/spaces, scenes, sounds and signage or other visual advertising. Each pathway and the environmental aspects are visualized by one or more animated flythroughs of internal and external perspectives, within which an attendee would experience a first person view of the assets, with the ability to self-select the ways and/or order in which the user interacts with some of the environmental assets (plenary sessions, breakout rooms, exhibition hall, video, audio and text content, for example, available or viewable along the pathway.

The floor plan template and virtual pathway are designed to efficiently accommodate new designs that easily link to the software. This allows for animations, and other visual environment assets to be quickly and automatically generated and then deployed without further coding development.

The floor plan template and virtual pathway allows for efficient, ongoing customization to the structures within the system. This allows for contingent visual assets such as sponsors logos, sponsors signage, additional breakout rooms, new exhibitor booths to be swapped in or out seamlessly and without further coding development.

Embodiments are implemented by a combination of hardware and software. For example, a computer hardware system that is configured to operate a number of software processes. The computer system may have any combination of local hardware devices and remote devices. For a computer system configured to support a virtual event platform, the computer system will typically comprise one or more interconnected servers, and one or more remote devices, such as smartphone or personal computing devices that connect to the one or more servers.

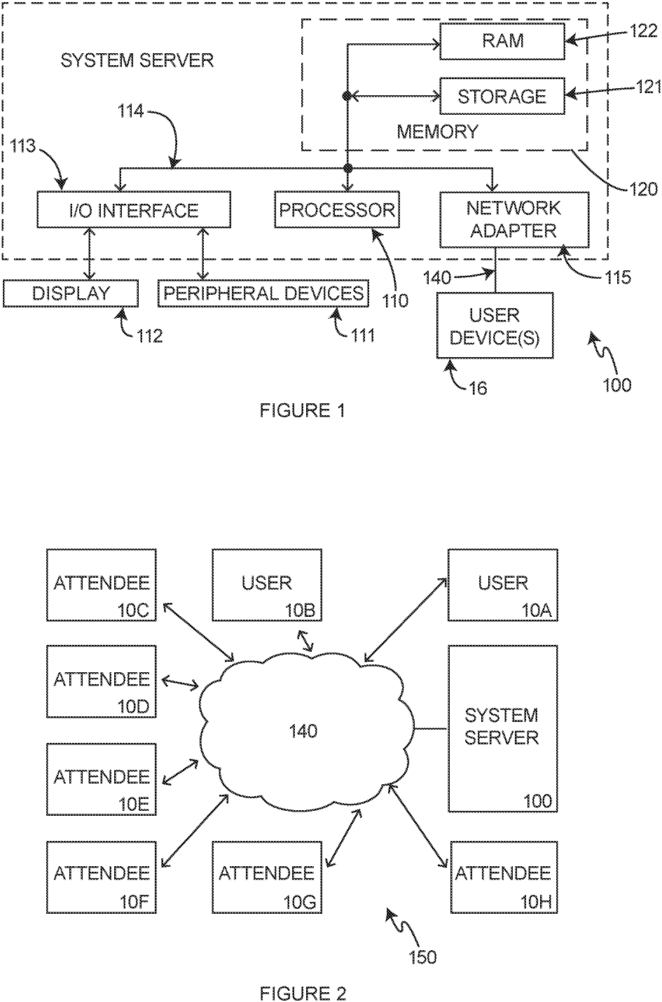

FIG. 1 shows an example of a computer system 100 configured to support embodiments. In some embodiments, the computer system is a node in a cluster of nodes. Each node may be, for example, a cloud computing system. The computing node is only one example of a suitable system, such as a cloud computing node, and is not intended to suggest any limitation as to the scope of use or functionality of embodiments of the invention described herein. Regardless, the computing node is capable of being implemented and/or performing any of the functionality set forth hereinabove.

In a cloud computing node there is a computer server system 100 that is operational with numerous other general purpose or special purpose computing system environments or configurations. Examples of well-known computing systems, environments, and/or configurations that may be suitable for use with computer system/server include, but are not limited to, personal computer systems, server computer systems, client computing devices, handheld or laptop devices, multiprocessor systems, microprocessor-based systems, programmable consumer electronics, network PCs, minicomputer systems, mainframe computer systems, and distributed cloud computing environments that include any of the above systems or devices, and the like.

The computer system server 100 may be described in the general context of computer system executable instructions, such as program modules, being executed by a computer system. Generally, program modules may include routines, programs, objects, components, logic, data structures, and so on that perform particular tasks or implement particular abstract data types. The computer system server 100 may be practiced in distributed cloud computing environments where tasks are performed by remote processing devices that are linked through a communications network. In a distributed cloud computing environment, program modules may be located in both local and remote computer system storage media including memory storage devices.

The computer system server is shown in the form of a general-purpose computing device. The components may include, but are not limited to, one or more processors or processing units 110, a system memory 120, and a data communications bus 114 that couples various system components including system memory 120 to processor 110. The data bus 114 represents one or more of any of several types of bus structures, including a memory bus or memory controller, a peripheral bus, an accelerated graphics port, and a processor or local bus using any of a variety of bus architectures.

The computer system server 100 typically includes a variety of computer system readable media. Such media may be any available media that is accessible by computer including both volatile and non-volatile media, removable and non-removable media. System memory 120 can include computer system readable media in the form of volatile memory, such as random access memory (RAM) 122 and/or cache memory. The computer system server 100 may further include other removable/non-removable, volatile/non-volatile computer system storage media. By way of example only, a storage system 121 is provided for reading from and writing to a non-removable, non-volatile drive media. In such instances, each can be connected to the data bus 114 by one or more data interfaces. As will be further depicted and described below, memory 120 may include at least one program product having program modules that are configured to carry out the functions of embodiments of the invention.

Programs for execution by computing devices may be stored in memory 120, as well as an operating system, one or more application programs, other programs, and program data. Each of the operating system, one or more application programs, other program modules, and program data or some combination thereof, may include an implementation of a networking environment. Programs generally carry out the functions and/or methodologies of embodiments of the invention as described herein.

The computer system server 100 may also communicate with one or more external peripheral devices 111 such as a keyboard, a pointing device, a display 112 and other like devices. Communication can occur via Input/Output (I/O) interfaces 113. The computer system/server 100 can communicate with one or more networks such as a local area network (LAN), a general wide area network (WAN), and/or a public network such as the Internet via network adapter 115. As depicted, network adapter 20 communicates with the other components of the system 100 via data bus 114. The network adapter 116 may facilitate connection with any one or more user devices 116, including smartphones, laptops, and other personal computing devices. Connection may be a wired and/or wireless interface, or facilitated by the internet.

The computer system server 100 is configured to store a program that, when executed in accordance with embodiments of the invention, operates the processor to undertake processes and implement functions according to embodiments.

The virtual event platform has “Users,” who are herein referred to as the operators of the platform, and “Attendees,” who are herein referred to as participants of the virtual event. In some embodiments, the users and the attendees each have their own computing devices 116 in connection with the server 100.

FIG. 2 shows a diagram of an environment 150 including the system server 100 connected to multiple Users 10a, 10b, and multiple attendees 10b-10h by way of a network 140. The users are those providing operational oversight to the processor operation and the functions implemented. The attendees are those connecting to the server and participating in the virtual event.

Expressions of the virtual event space are executed on the attendee computing platforms 10 may be configured to simply present views of the virtual space from the server 100 to attendee computing platforms for presentation to an attendee. The view determined and transmitted to a given attendee computing platform may correspond to the location of an attendee within the virtual event space, as being controlled by an attendee or user. The view determined and transmitted to a given client computing platform may correspond to a location in the virtual space (e.g., the location from which the view is taken, the location the view depicts, and/or other locations), a zoom ratio, a dimensionality of obj ects, a point-of-view, and/or view parameters. One or more of the view parameters may be selectable by the attendee. Data on each attendee’s journey through the virtual event space may be recorded by the server 100 for analysis and customer relationship management purposes.

Each attendee is delivered cinematic content in the form of downloadable or streamable media such as video and optionally audio data. The cinematic content is a visual representation of interaction with the virtual event space, including viewable graphical content, viewable video content, viewable environmental content, and viewable content representing movement through the virtual space. Accordingly, the system has a cinematic content generation engine configured to generate media for display on the attendee user device.

The instance of the virtual space may comprise a simulated space that presents the views of the primary virtual space to an attendee. The virtual space may have a topography and/or include one or more objects positioned within the topography that are capable of visual display, animation and other expressions. In some instances, the topography may be a two dimensional topography. In other instances, the topography may be a three dimensional topography. The topography may include or convey dimensions of the virtual space, and/or surface features of a surface or visual objects within the space. In some instances, the topography may describe a surface that runs through at least a substantial portion of the space. For example, in some embodiments the surface is a road or pathway that navigates the virtual space.

Views of the cinematic content within the virtual space may be selected from a first set of graphical elements depicting a place within the virtual space. The first set of graphical elements includes features that denote the nature of the virtual space. For example, the virtual space may be depicted by a conference centre or some other building or collection of buildings, an outdoor setting, or any of a variety of themes suitable for a virtual event space applicable for the event.

The views determined for the virtual space may further include additional content from a second set of graphical elements. The second set of elements may include pictures, text, audio, video content, and/or other content. The first set of graphical elements typically represents the event space, being relatively generic graphics, and the second set of graphical elements typically describes the particulars of the current state of the place and may be linked to the particular event topic, theme, product, or other specific event characteristics.

In some embodiments, the graphical content is linked to the type of event taking place. For example, a virtual event may be a schooling facility, and the graphical content is based on the subject matter relevant to the schooling.

The attendees may participate in the instance of the virtual space by controlling one or more of the available attendee controlled elements in the virtual space. Control may be exercised through control inputs and/or commands input by the attendees through individual client computing devices. In some embodiments, the attendees exercise control by selection of one or more virtual control surfaces.

In some embodiments, the virtual space comprises a number of pathways. Each pathway extends from one virtual floor plan location to another virtual floor plan location, i.e. between nodes. Pathways may extend from one location to another location, and/or from one location to multiple locations. An attendee is able to travel from one location to another available location by selection of a virtual button or similar input. The virtual button may represent travel between any locations linked by the pathway. Travel of the attendee means the display of cinematic content visually depicting movement through the virtual space from one node to another.

In some embodiments, the availability of pathways is controlled based on one or more of an event manager manually making pathways available, and/or by a scheduling controller comprising a schedule of pathways and times to thereby control the availability of pathways based on a time schedule. For example, some pathways may be available for selection and navigation by an attendee for a particular and limited time period. Further, some pathways are made available based on or more other pathways being navigated already. In this way, the event experienced by an attendee can be controlled in such a way that particular aspects of the event are viewed before others. Further control is provided in that attendees can be controlled to gather in a particular location within the event space at a particular time, such as to witness a keynote speaker. The availability of pathways means the attendee may be presented with one or more visual selections operable by the processor to control movement of the attendee from one node to another, or to activate some other function. The processor is configured to display one or more visual selections to the attendee, and based on a selection made by the attendee, output cinematic content accordingly.

The processor 110 may be configured to provide information processing capabilities in the computer system 100. Although the processor 110 is shown in as a single element, this is for illustrative purposes only, and may include a plurality of processing units. These processing units may be physically located within the same device or be multiple processors of multiple devices operating in coordination. The processor is configured to execute computer program modules. Reference to modules as used within this description is intended to be illustrative and not restrictive. Each module may represent a particular process or functionality as may be undertaken by any component of the system 100. Further, any module may provide more or less functionality than is described. For example, one or more of modules may be eliminated, and some or all of its functionality may be provided by one or more other modules. As another example, the processor 110 may be configured to execute one or more additional modules that may perform some or all of the functionality attributed to any module or modules. The processor itself may herein be referred to as a module.

In some embodiments, there is a virtual event space module configured to execute an instance of a virtual event space such as a virtual event location. The instance of the event space may comprise a simulated space that is accessible by attendees and present views of the event space to the attendee. The virtual event space may have a topography and/or include one or more objects positioned within the topography that are capable of visual display or animation within the topography.

In some embodiments, the virtual event space module is configured to implement the instance of the event space to facilitate display of event information to the attendees within the event space. In some embodiments, the virtual event space module is configured to perform operations in the virtual event space in response to commands received from the attendees or users providing manual or automated oversight of events within the virtual event space.

In some embodiments, views of the event space and/or travel through the event space are delivered to an attendee in the form of video content as rendered by a cinematic video processing module. Playback of the video content may be automatic, or triggered in response to an inputs received from the attendee via their computing device, such as selection of a navigation pathway. Video content is preferably delivered to attendee computing devices by way of a streamed or downloadable media file for playback on the attendee computing device.

In some embodiments, an event period may be the duration of time that some, or all, of the virtual event space is available to the attendees of the virtual space. At the expiration of the event period, the event space may no longer be available to the attendees of the virtual space. In other embodiments, the virtual event may be made available online for engagement or a repeated experience by attendees for future occasions. The event period may be any time period, and the time period may be adjusted by users. In this way, the timing of the program of the virtual event may be adjusted to allow for desired attendance in a particular area of the virtual event space. In some embodiments, the system is configured to allow users to notify attendees of event updates, event timing, changes to event occurrences and other scheduled or unscheduled events within the virtual space in order to elicit a desired action from an attendee.

In some embodiments, a user is charged with an “event manager” role. In such a role, the event manager is able to make real-time changes to a schedule of pathway accessibility, to change loaded graphical content, and/or to control event spaces.

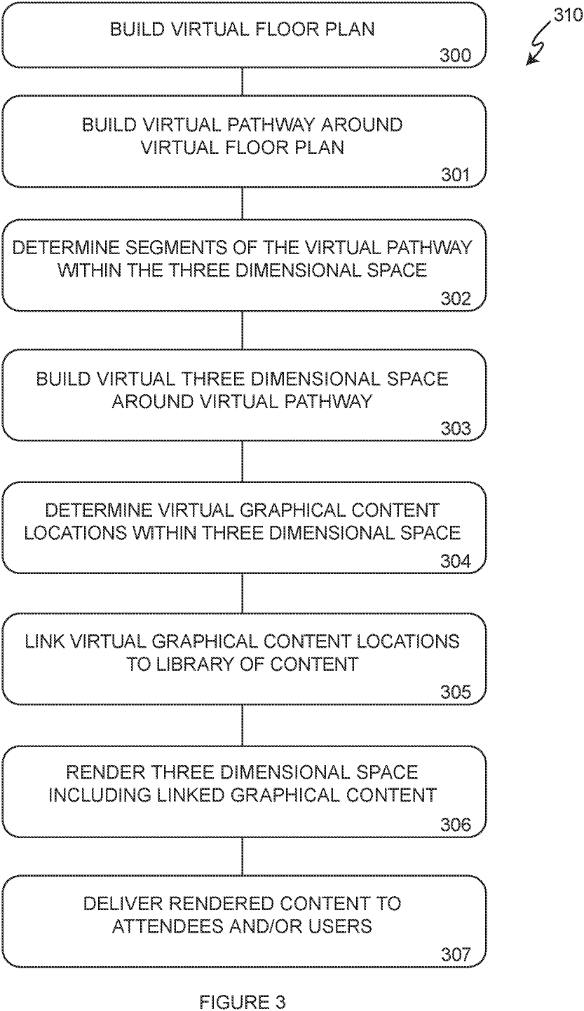

FIG. 3 illustrates a method 310 for providing a virtual event space in accordance with one or more implementations. The operations of the method 310 described below are intended to be illustrative. In some implementations, the method may be accomplished with one or more additional operations not described, and/or without one or more of the operations discussed. Additionally, the order in which the operations of method 310 are illustrated in FIG. 3 and described below are not intended to be limiting.

In some implementations, the method 310 may be implemented in one or more computing devices. The one or more computing devices may include one or more processors executing some or all of the operations of the method in response to instructions stored electronically on an electronic storage medium. The one or more processing devices may include one or more devices configured through hardware, firmware, and/or software to be specifically designed for execution of one or more of the operations of the method.

At an operation 300, a virtual floor plan is determined. The floor plan is determined by an event organizer as one that meets the expectations of the event space. The virtual floor plan for event space is intended to meet similar requirements as a real event space in terms of the number of rooms, size of rooms, the layout of rooms, and other factors. In some embodiments, the virtual floor plan is selected from a predetermined group of floor plans. In other embodiments, the system is configured to generate a floor plan based on a factors including of the number of rooms and layout of those rooms. The virtual floor plan may be, for example, a conference center for a conference, a shopping street for a market type event, a forest for a festival.

The floor plan guides the extent of the visual environment surrounding the virtual pathway. The floor plan design template is designed to efficiently accommodate new environments that are easily integrated. The floor plan design template allows for efficient, ongoing customization to the structures within the system. In some embodiments, one large virtual floor plan may be used as a basis for any number of smaller floor plans by selection of areas of the floor plan. In some embodiments, the floor plan, or selections of the floor plan are repeatable to increase the overall floor plan. In some embodiments, the floor plan is virtually infinitely expandable.

At an operation 301, a virtual pathway through the virtual floor plan is determined. The virtual pathway forms a basis for the visual construction of the virtual event space. The virtual pathway is intended to be the same for a variety of visual representations of virtual event spaces. However, other virtual pathways are possible. The virtual pathway is the pathway followed by attendees of the virtual event.

At an operation 302, the virtual pathway is segmented within the virtual floor plan. The segments are made up of two or more nodes located within the floor plan, and a pathway extending between the two or more nodes. Each segment may comprise one or more nodes, each node comprising one or more pathways that may extend to any other node. The nodes are typically arranged about the virtual floor plan so as to be located in a virtual room. However, nodes may be positioned at any location of interest within the virtual floor plan. Within the virtual event, the nodes and pathways create the travel path available to attendees, and therefore control the individual cinematic experience delivered to each attendee.

Each segment may represent a discrete area of the virtual space such as a room. Designation of a room allows that room to be provided with graphical content that represents the purpose of the room. The graphical content is typically visual content and includes brand-based content such colors, logos, text, product information, and audio such as environment specific sound bites, sounds effects, background music, or other recordings. For example, for a virtual event, one room may be an auditorium where attendees can view a speaker, and another room may include product information and contain display elements in support of that product.

At an operation 303, a three dimensional space is formed based on the virtual floor plan. The floor plan represents the virtual event space, and has a plurality of virtual event space configuration selections. Exemplary selections include a building size selection that matches the floor plan, a marketing theme selection, and a landscape selection. In some embodiments, the three dimensional space is prepared using AutoCAD dynamic blocks, autoLISP, server integration with AutoCAD.

At an operation 304, one or more virtual graphical content locations is accorded to the virtual event space. Each of the virtual graphical content locations represents the location of a replaceable graphical element. For example, the graphical element may include brand logos or colors. Further, the graphical content is intended to be selected by the creator of the virtual event, and as such, the content represents graphical elements linked to the virtual event.

The locations of the graphical elements are linked to the three dimensional space. In some examples, the locations are linked to a wall of a building, in other examples, the locations are visually represented as signboards within the virtual space.

In some embodiments, the user designing the virtual event selects the concentration of locations within the virtual event space. The concentration selection determines, for example, how many walls or signboards are available within the event space as locations for display of graphical content.

At an operation 305, the graphical content is selected for the available graphical elements. The graphical content is stored in a library of graphical content. The graphical content is linked or mapped to the graphical elements available in the virtual event space. In some embodiments, naming conventions are used to link graphical content to graphical elements. In an exemplary embodiment, a user loads graphics in the form of a .png or .jpeg file format into the system, then the graphical content is linked to the master CAD files using specific naming conventions. In preferred embodiments, the graphical content is interchangeable by the user, and by virtue of the naming conventions linking to graphical elements, a change in the graphical content library automatically changes the associated graphical elements within the virtual event space.

At an operation 306, the three dimensional virtual event space is rendered according to the selected floor plan, the selected three dimensional environment features based on the floor plan, and including the graphical content from the library according to the graphical contents locations. The rendering takes place in an engine configured to generate cinematic content. In some embodiments, the rendering is provided by the Unreal engine.

At an operation 307, the rendered content is delivered for use. For example, by delivery of one or more animated media files for streaming and playback by users and attendees. In preferred forms, the media files contain video content and optionally audio content. In some embodiments, the rendered content includes selectable content that is configured to allow the user to navigate the virtual pathway while simultaneously viewing the visual content of the environment and graphical content.

The above-described process provides for efficient creation of virtual event spaces for accommodating online attendees. From an event planning perspective, there is a particular performance improvement by enabling a virtual event space to be quickly and efficiently prepared through the use of template based floor plan data, and the linking of selectable graphical content for use in predetermined locations within the virtual event space as provided by the floor plan. A new or revised virtual event space can be quickly created by linking of replacement graphical content at any time. This process provides for efficient, ongoing customization to the structures within the system.

In some embodiments, the graphical content is stored in a database module for transmission to the content rendering processor. Each item of graphical content comprises data operable by the processor to identify the content, and link content to particular graphical content locations within the virtual event space. Similarly, virtual locations within the virtual event space also comprise location data. The processor is configured to link graphical content from the database with the virtual locations based on the identification data. The links are preferable defined by a user and stored for reference by the content rendering processor.

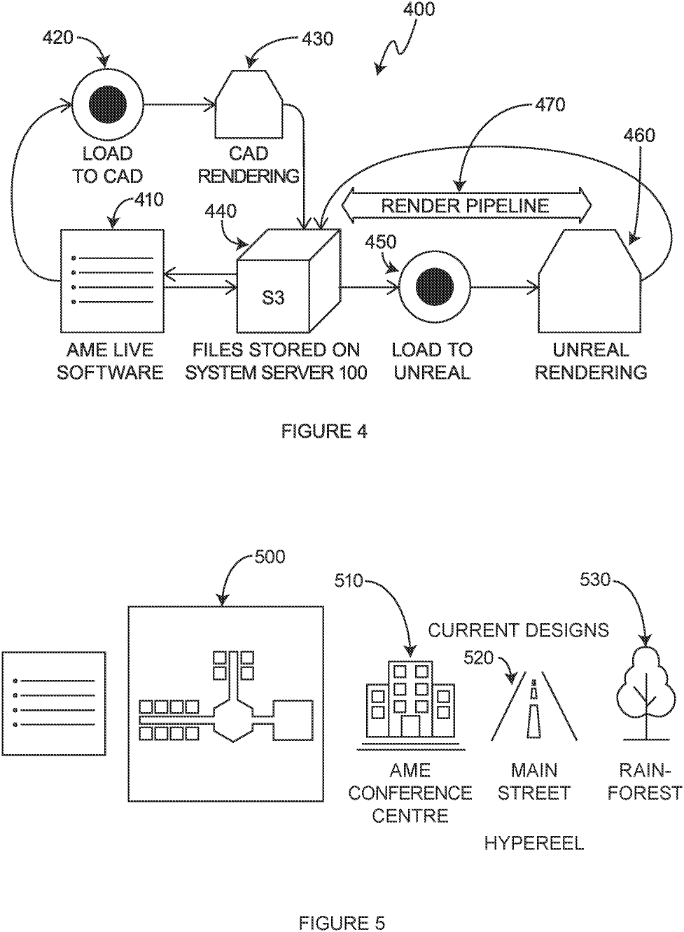

FIG. 4 shows a view of exemplary modules 400 within system 100 which are configured for the implementation of any one or more operations outlined in FIG. 3. An architecture module 410 operates to create floor plan and three dimensional structure data based on a selection made by a user of a building or floor plan template, which in turn is linked to the virtual pathway. The three-dimensional structure data is linked to any number of graphical content locations.

Module 420 receives the floor plan data and graphical content location data and loads the data to a three-dimensional CAD modelling operation. In some embodiments, the CAD modelling operation is provided by AUTOCAD.

Module 430 is configured to render the three-dimensional virtual event environment by the CAD program, and at least a link to graphical content provided by the user as linked to the predefined graphical content location within the virtual event environment.

Module 440 is configured to store the combined CAD data and graphical content data for conversion into the final three-dimensional rendering.

Module 450 is configured to load the combined CAD data and graphical content data to the cinematic rendering engine, such as the Unreal engine.

Module 460 is configured to render the CAD data and the graphical content data into final rendered cinematic content. The content is stored on the server as for module 430 for deliver to users and attendees.

Module 470 forms a rendering pipeline, whereby information is retrieved from module 430 and rendered into the final rendered cinematic content. The information stored on the server module 440 can be replaced at any time. For example, graphical content can be replaced, and floor plan information can be replaced, such as the replacement of graphics, colors, adding/removing of signage, turning on/off of elements, audio can also be turned on/off. In this way, module 450 is able to simplify form-rendering tasks based on the information made available on the server module 440. The time required to make changes to viewable content within the virtual event is simply a matter of rendering time. Time to regenerate the three dimensional space using conventional methods is therefore avoided.

In some embodiments, the pathway comprises one or more decision points. The decision points are prompts for input from one or more of the attendees. In some embodiments, the decision points are unique to the attendee or a group of attendees. In other embodiments, the decision points are provided to every attendee. Each attendee chooses to make a decision based on the decision points available. The outcome of the decision, for example, is travelling along a segment of the pathway. In such embodiments, the processor is configured to deliver media content of the journey along the pathway, including the interior view of the virtual event space and graphical content in the predetermined graphical locations.

In some embodiments, the system comprises one or more action points. Action points comprise determinations of attendee behavior. For example, attendee behavior may include time spent at any one or more locations within the virtual event space. The elapsed time spent may be compared to a threshold, which when exceeded, a change to the virtual event space occurs. One example of a change includes a new pathway being made available as a decision point. Another example may be a communication sent to the user regarding other places of interest within the event space.

FIG. 5 shows illustrative examples of options that may be provided to an organizer of a virtual event. For example, image 500 shows a floor plan of a conference center including multiple rooms; image 510 shows a three-dimensional rendering of a conference center; image 520 shows a rainforest; and image 530 shows a Main Street.

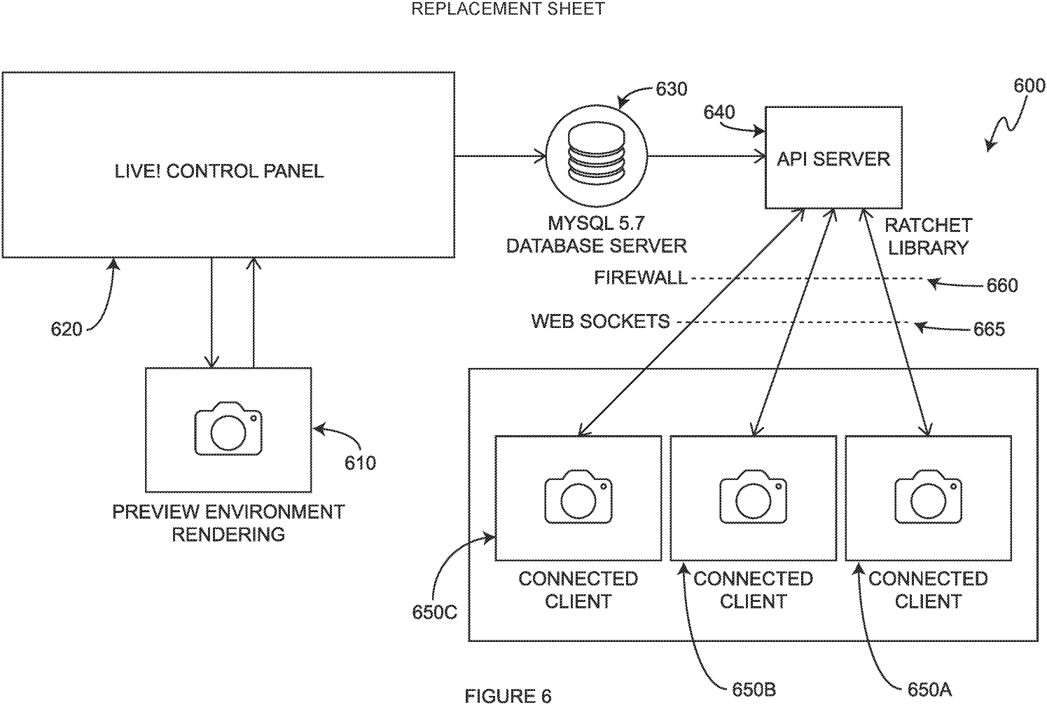

FIG. 6 shows a schematic view of system 600 including modules and a process whereby a user will build and facilitate a virtual event. Module 610 operates to show a user two-dimensional views of the rendered environment as a form of preview. In this way, graphical content loaded for the predetermined locations is able to be previewed.

Module 620 is a live control panel where a user may orchestrate the live virtual event in real-time. Controls facilitated by the control panel include: messaging to one or more attendees; a schedule for actions schedule in any one or more of the virtual rooms (segments of the floor plan); and making updates to any content shown within the virtual event.

Module 630 is a server as may be used to host any web-based virtual event. For example, the server may be MySQL based.

Module 640 is an API Server configured to facilitate data throughput. For example, the API is a secure PHP7 based server providing data in and data out in real time using standard websockets protocol. The server processes the requests from the control panel 620 and issues commands to clients.

Optional firewall 660 and bidirectional websockets 665 components provide authentication and connection functionality.

One or more attendees connect to the virtual events platform by way of their computing devices 650a, 650b, 650c.

In some embodiments, the Live Control Center is configured to facilitate full production controls for live virtual experiences, including the following: Audio and video testing in advance of going live; Speaker ready-prep and “hot holds” of speakers and content pre-show; Clear indicators of what programing is staged, live and complete; Rendered test mode of the final site in advance of the program; Communication between event teams, production team and speakers outside of the live environment; Creation and delivery of push notifications to attendees with the ability to test the technology in advance; Monitoring of chats before, during and after the event, including Creation of custom chat “rooms”; Visibility and analysis during and after the event on the location and behavior of all attendees.

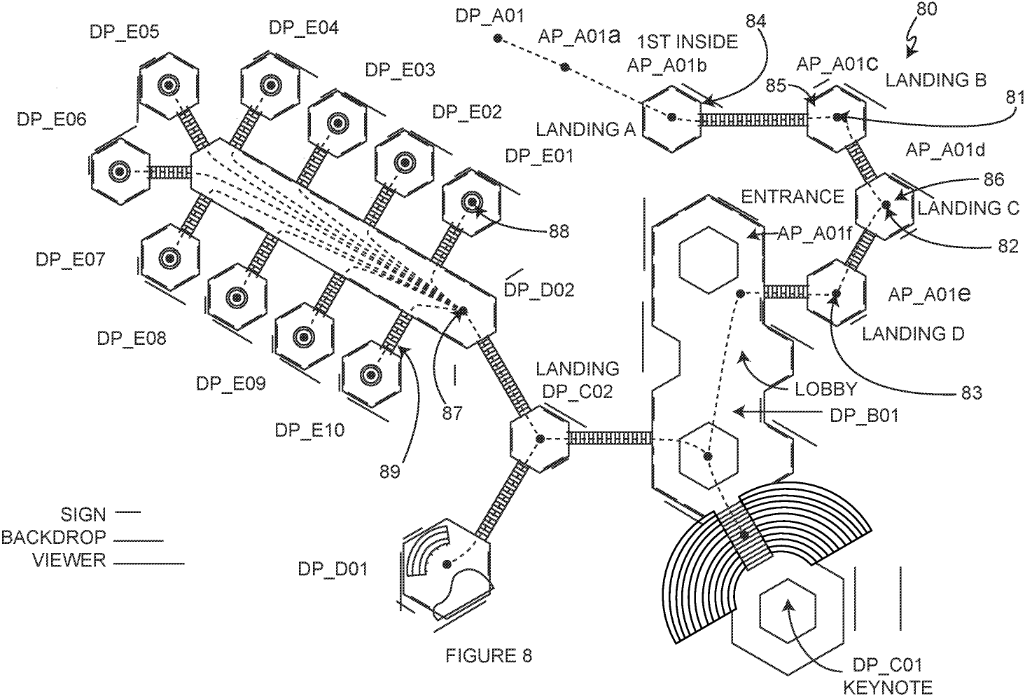

FIG. 8 shows an exemplary floor plan 80 and pathway overlaid on the floor plan. The floor plan comprises a number of rooms: “1^{st} Inside”, “Entrance”, “Lobby”, “Keynote”, “Landing A”, “Landing B”, “Landing C”, “Landing D”, “Network Alley”. A plurality of nodes is located within the floor plan. Between a selection of nodes, a navigation pathway is provided. For example, there is a pathway extending between Landing B node 81 and Landing C node 82, and from Landing C node 82 and to Landing D node 83. Some nodes have multiple pathways that extend from it. For example, node 87 has a plurality of nodes that extend, including node 88 and node 89, and the remaining nodes contain within floor plan locations DP_E01 to DP_E10.

In some embodiments, the schedule controller module is configured to change the available pathways that extend between nodes based on time or an action taking place, or a combination of actions taking place, or other control basis as may be applicable to the virtual event.

In some embodiments, the pathways are unidirectional. In this way, attendees can be guided from a start to a destination. Further, control of available pathways at any one time enables an attendee to be guided to a particular location of interest. For example, when a keynote speaker is scheduled to commence, unidirectional pathways from each node may be configured to point to the node where the keynote speaker is located.

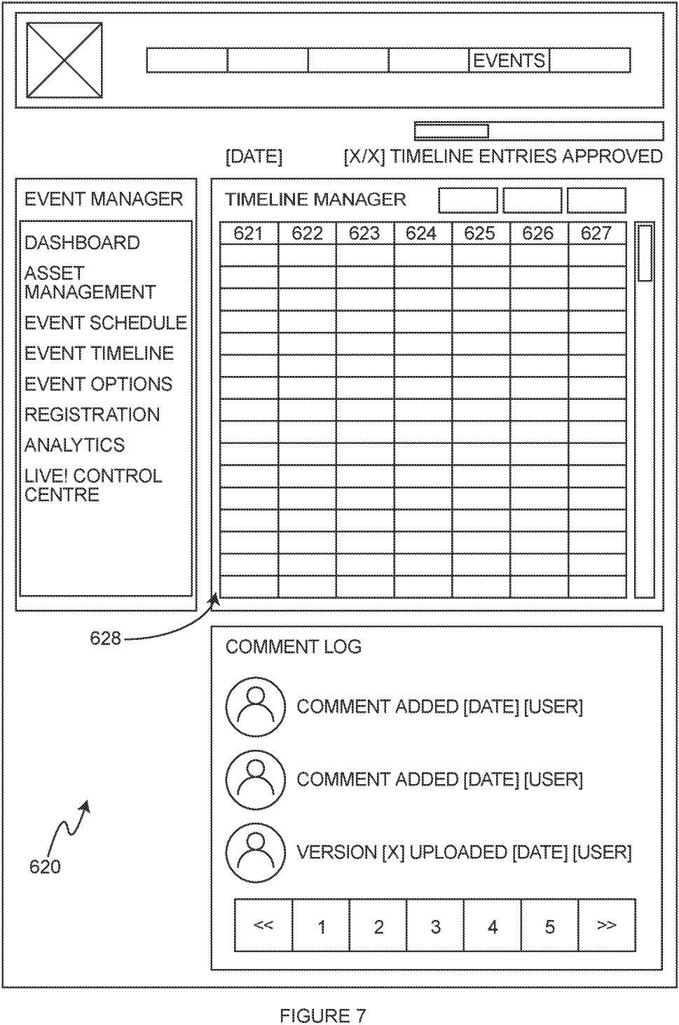

FIG. 7 shows an illustrative example of the control panel 620 including a timeline of scheduled actions within the virtual event. The schedule is time based 621, and for each time allotment 628, control of segments of the floor plan available for access by the attendees is provided. In the conference center example, the segments of the floor plan include an introduction 622, a lobby 623, a keynote 624, a breakout 625, a sponsor 626, and a networking alley 627. Each of the floor plan segments can be controlled and set to being open for access or closed based on how the event plan is intended to be undertaken. For example, at the beginning of the virtual event, the lobby area may be the only available area where attendees are able to access. Later in the schedule, a keynote speaker may be scheduled and as such, the virtual location of the speaker is made accessible, and other areas closed.

Therefore, the live schedule controller offers more control and a high production value for live virtual productions. They essentially up-level the production, allowing for a higher end, more cinematic result and greater control through the schedule builder. Ability to control the experience flow of the event. Flow can change both visually and practically (in terms of rooms “opening” / “closing”). The live schedule controller allows full control by the user of the following: Ability to adjust scheduling and content in “real-time”; Ability to turn on and off rooms / spaces within the virtual environment down to the second; Ability to adjust scheduling and content in “real-time.”

In some embodiments, the system is configured to log data representing user behavior within the virtual events platform. In some embodiments, the system is configured to store data including time an attendee spent in any segment of the virtual environment and the graphical content linked to that segment of the environment. In some embodiments, attendee data is stored on a CRM together with any data derived from attendance information within the environment.

According to one preferred embodiment, there is an interface provided to a user whereby a floor plan is selected or designed. The floor plan comprises one or more virtual locations of interest. In some embodiments, one or more pathways between two or more locations of interest are created, the pathways created within the floor plan.

Those skilled in the art will also appreciate that in some embodiments the functionality provided by the routines discussed above may be provided in alternative ways, such as being split among more routines or consolidated into fewer routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other embodiments the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by the appended claims and the elements recited therein. In addition, while certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

What is claimed is:

1. A method of generating a virtual event platform hosting virtual attendees, the method comprising operating a processor to:
receive virtual event space data comprising a floor plan, a plurality of nodes representing a plurality of virtual locations within the floor plan, a plurality of virtual pathways connecting a selection of the plurality of nodes, and a plurality of virtual graphical content locations within a virtual event space;
receive user data comprising identification of the virtual graphical content locations;
receive a selection of graphical content based on the user data;
render first person three-dimensional cinematic content at a virtual location represented by each node based on the virtual event space data and the selection of graphical content;
render three dimensional cinematic content comprising first person travel along each virtual pathway; and
output the first person three-dimensional rendered cinematic content to the virtual attendees.

2. The method of claim 1, wherein at least one node comprises a visual decision point, selectable by the virtual attendees, whereby selection of any one decision point causes the processor to output rendered cinematic content comprising travel through the virtual event space from one node to another.

3. The method of claim 1, further comprising transmitting data representing a virtual location of an attendee to a user server.

4. The method of claim 3, wherein the user server is configured to transmit notifications to an attendee device based on the data representing the virtual location of the attendee.

5. The method of claim 3, wherein the method further comprises operating the processor to output rendered cinematic content based on the data representing the virtual location of the attendee, the rendered cinematic content comprising new or existing virtual pathways between nodes.

6. The method of claim 1, wherein output of cinematic content comprising first person travel along each virtual pathway is based on control criteria, the control criteria comprising one or more of:
a time based component; or
a trigger component, the trigger component based on one or more behavioural characteristics of one or more of the virtual attendees.

7. The method of claim 1, wherein the processor is configured to output rendered cinematic content based on a schedule or timed events, and/or one or more inputs received from an attendee or user.

8. A system configured to operate a virtual event platform hosting virtual attendees, the system comprising a server connected to a plurality of virtual attendee devices, the server comprising a processor configured to:
receive virtual event space data comprising a floor plan, a plurality of nodes representing a plurality of virtual locations within the floor plan, a plurality of virtual pathways connecting a selection of the plurality of nodes, and a plurality of virtual graphical content locations within a virtual event space;
receive user data comprising identification of the virtual graphical content locations;
receive a selection of graphical content based on the user data;
render first person three-dimensional cinematic content at a virtual location represented by each node based on the virtual event space data and the selection of graphical content;
render three dimensional cinematic content comprising first person travel along each virtual pathway; and
output the first person three-dimensional rendered cinematic content to the virtual attendee devices.

9. The system of claim 8, wherein at least one node comprises a visual decision point, selectable by the virtual attendees, whereby selection of any one decision point causes the processor to output rendered cinematic content comprising travel through the virtual event space from one node to another.

10. The system of claim 8, wherein the processor is further configured to transmit data representing a virtual location of an attendee to the server.

11. The system of claim 10, wherein the processor is further configured to transmit notifications to an attendee device based on the data representing the virtual location of the attendee.

12. The system of claim 10, wherein the processor is further configured to output rendered cinematic content based on the data representing the virtual location of the attendee, the rendered cinematic content comprising new or existing virtual pathways between nodes.

13. The system of claim 8, wherein output of cinematic content comprising first person travel along each virtual pathway is based on control criteria, the control criteria comprising one or more of:
a time based component; or
a trigger component, the trigger component based on one or more behavioural characteristics of at least one of the virtual attendees.

14. The system of claim 8, wherein the processor is further configured to output rendered cinematic content based on a schedule or timed events, and/or one or more inputs received from an attendee or user.
